(19) United States
(12) Patent Application Publication
(10) Pub. No.: US 2026/0056377 A1
(43) Pub. Date: Feb. 26, 2026

(54) CO-PACKAGED OPTICS NETWORK SWITCH WITH FAN INTEGRATED REAR PORTS

(71) Applicant: Dell Products L.P., Round Rock, TX (US)

(72) Inventors: Padmanabhan Narayanan, Chennai (IN); Shree Rathinasamy, Georgetown, TX (US); Robert Neal Beard, Austin, TX (US)

(21) Appl. No.: 18/814,877

(22) Filed: Aug. 26, 2024

(51) Int. Cl. G02B 6/42; H04B 10/40

(52) U.S. Cl. CPC G02B 6/4261; G02B 6/4269; G02B 6/4278; G02B 6/428; H04B 10/40

(57) ABSTRACT

A network switch. The network switch includes: a motherboard, including: at least one set of rear ports disposed at a rear portion thereof, each set of rear ports of the at least one set of rear ports including a rear port; at least one fan slot disposed behind the motherboard and aligned with the at least one set of rear ports, respectively; and at least one caged fan module respectively inserted into the at least one fan slot. Each caged fan module of the at least one caged fan module includes: a fan module; a set of cage front ports disposed in front of the fan module, and including a cage front port configured to mate with the rear port; and a set of cage rear ports disposed at a rear of the caged fan module, and including a cage rear port operatively connected to the cage front port.

### BACKGROUND

While co-packaged optics (CPO) network switches provide a lot of advantages, there is a need to analyze the network switch to identify even greater port density to ensure scalability of hyper-scalers and artificial intelligence (AI)/machine learning (ML) clusters. With the CPO network switch's front panel already maxed out by the number of fiber-optic ports it can support, the rear of the network switch allows opportunities to host more ports.

### SUMMARY

In general, in one aspect, embodiments described herein relate to a network switch. The network switch includes: a motherboard, including: at least one set of rear ports disposed at a rear portion thereof, each set of rear ports of the at least one set of rear ports including a rear port; at least one fan slot disposed behind the motherboard and aligned with the at least one set of rear ports, respectively; and at least one caged fan module respectively inserted into the at least one fan slot. Each caged fan module of the at least one caged fan module includes: a fan module; a set of cage front ports disposed in front of the fan module, and including a cage front port configured to mate with the rear port; and a set of cage rear ports disposed at a rear of the caged fan module, and including a cage rear port operatively connected to the cage front port.

In general, in one aspect, embodiments described herein relate to a caged fan module. The caged fan module includes: a fan module; a set of cage front ports disposed in front of the fan module, and including a cage front port; and a set of cage rear ports disposed at a rear of the caged fan module, and including a cage rear port operatively connected to the cage front port.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1 shows a network switch in accordance with one or more embodiments described herein.

FIGS. 2A-2C show isometric, front, and rear views of a caged fan module in accordance with one or more embodiments described herein.

FIG. 3 shows a fan slot occupation process in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to a co-packaged optics network switch with fan integrated rear ports. Particularly, networking switches are rapidly seeing an increase in their supported port speed such as 400 Gigabit Ethernet (GbE) and 800 GbE to aid in robust builds of high-speed network fabrics. This is further enhanced by the demand for the networking fabric to support high speeds to support AI/ML clusters. Traditional pluggable optics bring in their own challenges since the electrical trace lengths on the network switch and signal integrity come into play at higher speeds. Signal degradation and electromagnetic interference (EMI) can also pose a problem at higher speeds. With data centers already severely challenged by the power requirements, pluggable optics comparatively consumes more power as opposed to CPO. Higher port density are also closely looked at as the traditional port foot print remains a constraint. With so many challenges prevalent with the pluggable optic network switches, there is a greater interest and adoption of CPO network switches for high-speed networks.

While CPO network switches provide a lot of advantages, there is a need to analyze the network switch to identify even greater port density to ensure scalability of hyper-scalers and AI/ML clusters. With the CPO network switch's front panel already maxed out by the number of multiple-fiber termination push-on (MTP)/multi-fiber push-on (MPO) ports it can support, the rear of the network switch allows opportunities to host more ports. The power supply unit (PSU) side of a network switch typically has 2 PSUs (on the extreme left & right ends). A one rack unit (1RU) network switch has anywhere between 5 to 7 fan tray modules which are field replaceable from the rear. It is to be noted that fan trays have one of the lowest field incident rates (FIR) on a network switch. In existing network switch designs, there is sufficient space between the network switch (mother) board and the fan slots. It is therefore possible to extend the network switch (mother) board to accommodate additional MTP/MPO ports that are accessible (for cable insertion/removal) from the rear through the fan modules. Further, the solution provides faster serviceability by boasting plug and play capability.

Embodiments described herein thus propose a CPO network switch design with rear ports, a corresponding fan module design that can accommodate the rear ports, as well as internal cabling for rear ports to cage rear ports connectivity. Replacement of any transceivers/cables is made possible by first unplugging the corresponding fan module, performing the replacement, and then plugging in the fan module as illustrated and described in further detail herein.

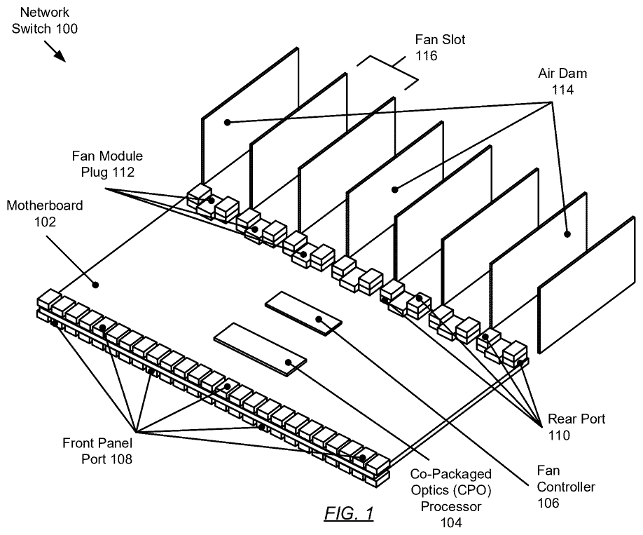

FIG. 1 shows a network switch in accordance with one or more embodiments described herein. The network switch (100) represents a physical, high-performance device configured to connect network servers, storage devices, and other network appliances within enterprise (e.g., on-premises and/or cloud computing infrastructure) environments. Said connection between enterprise environment elements may be implemented over one or more networks (e.g., local area networks (LANs), wide area networks (WANs) such as the Internet, mobile networks, etc.).

In one or many embodiment(s) described herein, the network switch (100) includes a chassis (not shown) representing, and thus serving as, a structural frame or housing within which other (internal) components of the network switch (100) may be enclosed and/or to which one or more of said other components may be affixed or mounted. The chassis may be assembled from multiple panels (not shown) that may be fastened together using any number and any form of mechanical fasteners (e.g., screws, bolts, latches, rivets, etc.) (not shown). Further, the chassis may be constructed of lightweight, yet rigid and durable materials such as, for example, steel, aluminum, plastics, carbon fiber, composites, or any combination thereof.

In one or many embodiment(s) described herein, the above-mentioned other (internal) components of the network switch (100) include a motherboard (102), a co-packaged optics (CPO) processor (104), a fan controller (106), multiple front panel ports (108), multiple rear ports (108), multiple fan module plugs (112), and multiple fan slots (118). Each of these network switch (100) (internal) components is described below.

In one or many embodiment(s) described herein, the motherboard (102) represents a physical printed circuit board (PCB) configured to interconnect, facilitate communications amongst, and distribute power to one or more electronic and/or electro-mechanical components (e.g., CPO processor (104), fan controller (106), front panel ports (108), rear ports (110), fan module plugs (112), power supplies (not shown), fan modules (not shown), storage/memory devices (not shown), etc.) of the network switch (100). One of ordinary skill, however, will appreciate that the motherboard (102) may perform other functionalities without departing from the scope of the embodiments described herein.

In one or many embodiment(s) described herein, the CPO processor (104) represents a single integrated circuit package, of electrical (i.e., silicon) and photonic (i.e., optical) dies, configured to govern a networking behavior, or implement any specified networking functionalities, of the network switch (100). To said extent, and at least in part, the CPO processor (104) includes functionality to: receive, process, and forward any network traffic (e.g., network packets) traversing the network switch (100) in order to reach any number of other enterprise environment systems directly or indirectly connected thereto. The CPO processor (104), more specifically, utilizes various constructs (e.g., data structures, rules, policies, etc.) (not shown) to determine out of which port(s) (e.g., front panel port(s) (108) and/or rear port(s) (110)) to forward any received network traffic. Reception and transmission of any network traffic, moreover, may be facilitated via fiber-optic (e.g., MTP/MPO) links. By way of examples, the electrical/silicon portion of the CPO processor (104) may be implemented as a central processing unit (CPU), a network processing unit (NPU), a field programmable gate array (FPGA), an application specific integrated circuit (ASIC), or any combination thereof.

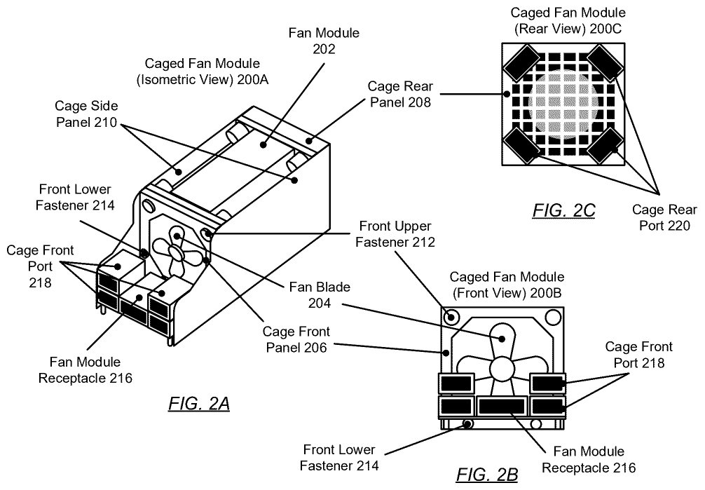

In one or many embodiment(s) described herein, the fan controller (106) represents an integrated circuit configured to control and/or manage one or more fan modules (or caged fan modules) (not shown) (see e.g., FIGS. 2A-2C). To said extent, the fan controller (106) may include, or may operatively connect to, any number of temperature sensors (not shown) through which an internal ambient temperature of the network switch (100) may be derived. Further, based on said internal ambient temperature, the fan controller (106) may implement any proper heat transfer and airflow circulation responsibilities via active cooling of any heat generating components (e.g., CPO processor (104), fan controller (106), etc.) of the network switch (100). By way of examples, the fan controller (106) may be implemented as an ASIC, a microcontroller, or any combination thereof.

In one or many embodiment(s) described herein, any front panel port (108) represents a communications receptacle mounted on a front-facing portion of the motherboard (102) and operatively connected to the CPO processor (104). Any front panel port (108), further, may at least in part be exposed or accessible through a front panel (not shown) of the chassis (not shown) of the network switch (100), where any front panel port (108) may be configured to receive a fiber-optic transceiver (not shown). Any front panel port (108) provides or includes fiber-optic links, which mate with counterpart fiber-optic links, of the received fiber-optic transceiver. Said fiber-optic transceiver may provide or include a connector (e.g., MTP/MPO fiber-optic link connector, a little/local connector (LC) fiber-optic link connector, etc.) for terminating one end of a compatible transceiver cable (not shown). Any front panel port (108), moreover, may enable (wired) high-speed telecommunication and/or data communications between the network switch (100) and any number of other enterprise environment systems. By way of an example, any front panel port (108) may be implemented as a MTP/MPO port or a LC port.

In one or many embodiment(s) described herein, any rear port (110) represents a communications plug or receptacle mounted on a rear-facing portion of the motherboard (102) and operatively connected to the CPO processor (104). Any rear port (110), further, may at least in part be exposed within or accessible through a fan slot (116), where any rear port (110) may be configured to receive a cage front port (not shown) (see e.g., FIGS. 2A-2C). Any rear port (110) provides or includes fiber-optic links, which mate with counterpart fiber-optic links, of the received cage front port (representing a mating communications receptacle or plug, respectively). Any rear port (110), moreover, may enable (wired) high-speed telecommunication and/or data communications between the network switch (100) and any number of other enterprise environment systems. By way of an example, any rear port (110) may be implemented as a MTP/MPO port or a LC port.

In one or many embodiment(s) described herein, any fan module plug (112) represents a male connector mounted on a rear-facing portion of the motherboard (102) and operatively connected to the fan controller (106). Any fan module plug (112) may be configured for insertion into a counterpart female connector (e.g., fan module receptacle (see e.g., FIGS. 2A-2C)) of a caged fan module (not shown). Any fan module plug (112), furthermore, may provide or include copper conductors through which fan module power and control signals may propagate in order to operate the caged fan module. By way of an example, any fan module plug (112) may be implemented using a standard board-to-board, right-angle power and signal connector plug.

In one or many embodiment(s) described herein, any fan slot (116) represents a bay or a space, which is disposed at the rear of the network switch (100), and is configured to receive or accommodate a fan module (or a caged fan module) (see e.g., FIGS. 2A-2C). Any fan slot (116), furthermore, includes a pair of air dams (114), where at least one of said pair may be shared with another (neighboring) fan slot (116).

In one or many embodiment(s) described herein, any air dam (114) represents an immobile barrier that not only functions as a side panel for a fan slot (116) but also serves to prevent airflow leakage between fan slots (116). Any air dam (114) may be constructed, for example, of steel sheet, and reflects a height defined by the distance between the bottom and top panels (not shown) of the chassis (not shown) of the network switch (100) as well as a length matching that of any caged air module (not shown).

In one or many embodiment(s) described herein, each fan slot (116) may align with a fan module plug (112) and up to four (4) rear ports (110) disposed on the rear-facing portion of the motherboard (102). The arrangement of said fan module plug (112) and said rear port(s) (110) may be such that the former aligns with a midpoint of a width of said fan slot (116), whereas each of the latter is adjacent to the former. That is, in one or many embodiment(s) described herein, the rear port(s) (110) may form stacks of up to two thereof, where each said stack may be disposed adjacent to (i.e., on either side of) the fan module plug (112) (as illustrated in FIG. 1). In one or many other embodiment(s) described herein, the rear port(s) (110) may be disposed relative to the fan module plug (112) such that: (a) one rear port (110) is adjacent to (i.e., on one side of) the fan module plug (112); one rear port (110) is adjacent to (i.e., on another side of) the fan module plug (112); and (c) up to two rear ports (110) is/are adjacent to (i.e., on top of) the fan module plug (112), where said up to two rear ports (110) is/are not stacked but rather disposed adjacent to (i.e., side by side) one another.

While FIG. 1 shows a configuration of components and/or subcomponents, other network switch (100) configurations may be used without departing from the scope of the embodiments described herein.

FIGS. 2A-2C show isometric, front, and rear views of a caged fan module in accordance with one or more embodiments described herein. The caged fan module (200A, 200B, 200C) represents a fan module (202) at least partially enclosed within a fan cage. The fan cage, in turn, represents, and thus serves as, a structural frame or housing within which the fan module (202) may at least be partially enclosed and/or to which the fan module (202) may, at least in part, be affixed or mounted. The fan cage may be assembled from multiple panels (e.g., cage front panel (206), cage rear panel (208), and cage side panels (210)) that may be fastened together, or to the fan module (202), using any number and any form of mechanical fasteners (e.g., front upper fasteners (212), front lower fasteners (214), rear upper fasteners (not shown), and rear lower fasteners (not shown)). The fan cage may serve other functionalities such as, for example, prevent any dust and debris from accumulating directly on the fan blades (204), thereby protecting, as well as facilitating any warranted cleaning of, the fan blades (204). Further, the fan cage may be constructed of lightweight, yet rigid and durable materials such as, for example, steel, aluminum, plastics, carbon fiber, composites, or any combination thereof.

In one or many embodiment(s) described herein, the fan module (202) represents a physical device configured to provide active cooling to one or more (internal) components of the network switch. Active cooling refers to a heat-reducing framework that consumes energy (e.g., electrical power) in order to implement proper heat transfer and airflow circulation. To said extent, the fan module (202) includes functionality to: draw in cool air from the surroundings outside, and at the front of, the network switch; move said cool air over/across one or more (internal) components of the network switch, which thereby absorbs at least a portion of any heat generated by said (internal) component(s) to become hot air; and expel said hot air from the network switch into the surroundings outside, and at the rear of, the network switch.

In one or many embodiment(s) described herein, the caged fan module (200A, 200B, 200C) includes a pair (2) of cabling tunnels (not shown) disposed at the bottom left and right sides of the caged fan module (200A, 200B, 200C). Specifically, each cabling tunnel runs along at least a portion of a length of the caged fan module (200A, 200B, 200C) on a respective side of the fan module (202). Each cabling tunnel, further, functions as passageway through which up to two fiber-optic cables may be routed to operatively connect up to two cage front ports (218) to up to two cage rear ports (220), respectively.

In one or many embodiment(s) described herein, the caged fan module (200A, 200B, 200C) includes a fan module receptacle (216) disposed in front of the cage front panel (206) and between the pair (2) of cage side panels (210). The fan module receptacle (216) represents a female connector operatively connected to the fan module (202) and configured to receive a counterpart male connector (e.g., fan module plug (see e.g., FIG. 1)) through which fan module (202) power and control signals may propagate in order to operate the fan module (202). By way of an example, the fan module receptacle (216) may be implemented using a standard board-to-board, right-angle power and signal connector receptacle.

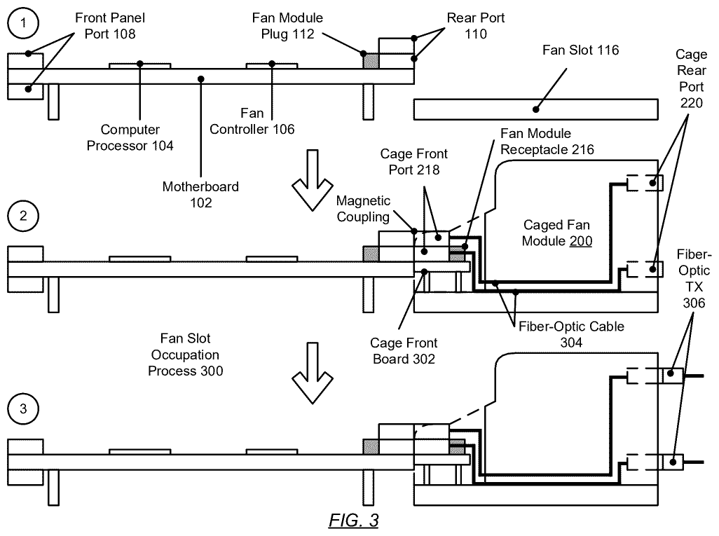

In one or many embodiment(s) described herein, the caged fan module (200A, 200B, 200C) includes up to four (4) cage front ports (218) disposed in front of the cage front panel (206) and between the pair (2) of cage side panels (210). Each cage front port (218) represents a male or female connector operatively connected (e.g., via a fiber-optic cable (not shown) (see e.g., 304, FIG. 3)) to a cage rear port (220) (see e.g., FIG. 2C) and configured to mate with a counterpart female or male connector (e.g., rear port (see e.g., FIG. 1)) through which network traffic may be received and/or transmitted by the network switch. By way of an example, each cage front port (218) may be implemented as a MTP/MPO port or a LC port.

In one or many embodiment(s) described herein, an arrangement of the fan module receptacle (216) and the cage front port(s) (218) may be such that the former resides in the middle (i.e., equidistant from the pair (2) of cage side panels (210)) of the caged fan module (200A, 200B, 200C), whereas each of the latter is adjacent to the former. That is, in one or many embodiment(s) described herein, the cage front port(s) (218) may form stacks of up to two thereof, where each said stack may be disposed adjacent to (i.e., on either side of) the fan module receptacle (216) (as illustrated in FIGS. 2A & 2B). In one or many other embodiment(s) described herein, the cage front port(s) (218) may be disposed relative to the fan module receptacle (216) such that: (a) one cage front port (218) is adjacent to (i.e., on one side of) the fan module receptacle (216); one cage front port (218) is adjacent to (i.e., on another side of) the fan module receptacle (216); and (c) up to two cage front ports (218) is/are adjacent to (i.e., on top of) the fan module receptacle (216), where said up to two cage front ports (218) is/are not stacked but rather disposed adjacent to (i.e., side by side) one another.

In one or many embodiment(s) described herein, the fan module receptacle (216) and the up to four (4) cage front ports (218) may be mounted on top of a cage front board (not shown) (see e.g., 302, FIG. 3). The cage front board

In one or many embodiment(s) described herein, the caged fan module (200A, 200B, 200C) includes a pair of front upper fasteners (212) (e.g., screws) disposed at the upper left and right corners of the cage front panel (206). The front upper fasteners (212), at least in part (i.e., alongside the front lower fasteners (214)), serve to fasten the cage front panel (206) to a front face (not shown) of the fan module (202). Further, by way of example, each front upper fastener (212) may be implemented using a M3×20 screw (defined by 2.9 millimeter diameter and 20 millimeter length).

In one or many embodiment(s) described herein, the caged fan module (200A, 200B, 200C) includes a pair (2) of rear upper fasteners (not shown) (e.g., screws) disposed at the upper left and right corners of the cage rear panel (208). The rear upper fasteners, at least in part (i.e., alongside the rear lower fasteners (not shown)), serve to fasten the cage rear panel (208) to a rear face (not shown) of the fan module (202). Further, by way of an example, each rear upper fastener may be implemented using a M3×20 screw (defined by 2.9 millimeter diameter and 20 millimeter length).

In one or many embodiment(s) described herein, the caged fan module (200A, 200B, 200C) includes a quartet (4) of front lower fasteners (214) (e.g., screws) disposed at the lower left and right corners of the cage front panel (206). Specifically, at each said corner and in accommodation of a cabling tunnel (not shown) passing through at least a portion of said corner, a pair (2) of the quartet (4) of front lower fasteners (214) may be positioned diagonally from one another. Each of said pair (2) of the quartet (4) of front lower fasteners (214) are smaller fasteners that replace a single larger fastener (e.g., similar to a front upper fastener (212)) in order to, at least in part (i.e., alongside the front upper fasteners (212)), serve to fasten the cage front panel (206) to a front face (not shown) of the fan module (202). Further, by way of an example, each front lower fastener (214) may be implemented using a M2×20 screw (defined by 1.9 millimeter diameter and 20 millimeter length).

In one or many embodiment(s) described herein, the caged fan module (200A, 200B, 200C) includes a pair (2) of rear lower fasteners (not shown) (e.g., screws) disposed at the lower left and right corners of the cage rear panel (208). The rear lower fasteners, at least in part (i.e., alongside the rear upper fasteners (not shown)), serve to fasten the cage rear panel (208) to a rear face (not shown) of the fan module (202). Further, by way of an example, each rear lower fastener may be implemented using a M3×20 screw (defined by 2.9 millimeter diameter and 20 millimeter length).

In one or many embodiment(s) described herein, the caged fan module (200A, 200B, 200C) includes up to four (4) cage rear ports (220) disposed at a rear thereof. Particularly, each cage rear port (220) may occupy, and at least in part protrude through a portion of, a corner of the cage rear panel (208) (as illustrated in FIG. 2C). Each cage rear port (220), furthermore, represents a female connector operatively connected (e.g., via a fiber-optic cable (not shown) (see e.g., 304, FIG. 3)) to a cage front port (218) and configured to receive a fiber-optic transceiver (not shown) (see e.g., 306, FIG. 3). Each cage rear port (220) provides or includes fiber-optic links, which mate with counterpart fiber-optic links, of the received fiber-optic transceiver. Said fiber-optic transceiver (TX) may provide or include a connector (e.g., MTP/MPO fiber-optic link connector, a little/local connector (LC) fiber-optic link connector, etc.) for terminating one end of a compatible transceiver cable (not shown). Each cage rear port (220), moreover, may enable (wired) high-speed telecommunication and/or data communications between the network switch (100) and any number of other enterprise environment systems. By way of an example, any cage rear port (220) may be implemented as a MTP/MPO port or a LC port.

FIG. 3 shows a fan slot occupation process in accordance with one or more embodiments described herein. The fan slot occupation process (300) pertains to the insertion of a caged fan module (200, 200A, 200B, 200C) within a fan slot (116) disposed at the rear of a network switch (see e.g., FIG. 1). To that extent, the fan slot occupation process (330) includes the following sequence of steps:
1. The (unoccupied) fan slot (116), disposed at the rear of the network switch, is identified [note: air dams (see e.g., 114, FIG. 1) of the fan slot (116) are intentionally not shown so as to not obstruct the viewing of certain components of the caged fan module (200, 200A, 200B, 200C)]; aligned with the fan slot (116) and disposed on the motherboard (102) are a fan module plug (112) and up to four (4) rear ports (110)
2. The caged fan module (200, 200A, 200B, 200C) is inserted into the fan slot (116); the fan module plug (112) and the fan module receptacle (216) mate via a latching mechanism, whereas each rear port (110) mates with a corresponding cage front port (218) via magnetic coupling (e.g., using small high-powered neodymium magnets embedded along the corners of each rear port (110) and each cage front port (218))
3. Once the caged fan module is seated/locked into place, up to four (4) fiber-optic transceivers (TX) (306) is/are inserted into the up to four (4) cage rear ports (220), respectively, thereby enabling network connectivity to other enterprise environment systems using up to four (4) other fiber-optic cables

While the embodiments described herein have been disclosed with respect to a limited number of embodiments, those skilled in the art, having benefit of this disclosure, will appreciate that other embodiments can be devised which do not depart from the scope of the embodiments described herein. Accordingly, the scope of the embodiments described herein should be limited only by the attached claims.

What is claimed is:

1. A network switch, comprising:
a motherboard, comprising:
at least one set of rear ports disposed at a rear portion thereof, each set of rear ports of the at least one set of rear ports comprising a rear port;
at least one fan slot disposed behind the motherboard and aligned with the at least one set of rear ports, respectively; and
at least one caged fan module respectively inserted into the at least one fan slot, each caged fan module of the at least one caged fan module comprising:
a fan module;
a set of cage front ports disposed in front of the fan module, and comprising a cage front port configured to mate with the rear port; and
a set of cage rear ports disposed at a rear of the caged fan module, and comprising a cage rear port operatively connected to the cage front port.

2. The network switch of claim 1, the motherboard further comprising a co-packaged optics (CPO) processor operatively connected to the at least one set of rear ports.

3. The network switch of claim 1, the motherboard further comprising a fan controller and at least one fan module plug operatively connected thereto, the at least one fan module plug comprising a fan module plug, and wherein the at least one fan slot also aligns with the at least one fan module plug, respectively.

4. The network switch of claim 3, wherein the rear port is disposed adjacent to the fan module plug.

5. The network switch of claim 3, wherein the caged fan module further comprises a fan module receptacle also disposed in front of the fan module and configured to mate with the fan module plug, and wherein the cage front port is disposed adjacent to the fan module receptacle.

6. The network switch of claim 1, wherein the cage front port mates with the rear port through magnetic coupling.

7. The network switch of claim 1, wherein the cage rear port operatively connects to the cage front port using a fiber-optic cable routed through at least a portion of a length of the fan module.

8. The network switch of claim 1, wherein the rear port, the cage front port, and the cage rear port utilize multi-fiber push-on (MPO) technology.

9. The network switch of claim 1, the set of rear ports further comprising a second rear port, wherein the set of cage front ports further comprises a second cage front port configured to mate with the second rear port, and wherein the set of cage rear ports further comprises a second cage rear port operatively connected to the second cage front port.

10. The network switch of claim 9, the set of rear ports further comprising a third rear port, wherein the set of cage front ports further comprises a third cage front port configured to mate with the third rear port, and wherein the set of cage rear ports further comprises a third cage rear port operatively connected to the third cage front port.

11. The network switch of claim 10, the set of rear ports further comprising a fourth rear port, wherein the set of cage front ports further comprises a fourth cage front port configured to mate with the fourth rear port, and wherein the set of cage rear ports further comprises a fourth cage rear port operatively connected to the fourth cage front port.

12. The network switch of claim 1, wherein the cage rear port is configured to receive a fiber-optic transceiver.

13. The network switch of claim 1, wherein the cage rear port is disposed more specifically at a corner of the rear of the caged fan module.

14. A caged fan module, comprising:
a fan module;
a set of cage front ports disposed in front of the fan module, and comprising a cage front port; and
a set of cage rear ports disposed at a rear of the caged fan module, and comprising a cage rear port operatively connected to the cage front port.

15. The caged fan module of claim 14, wherein the cage rear port operatively connects to the cage front port using a fiber-optic cable routed through at least a portion of a length of the fan module.

16. The caged fan module of claim 14, wherein the cage front port is configured to mate with a rear port, through magnetic coupling, of a motherboard disposed ahead of the caged fan module.

17. The caged fan module of claim 14, the set of cage front ports further comprising a second cage front port, and wherein the set of cage rear ports further comprises a second cage rear port operatively connected to the second cage front port.

18. The caged fan module of claim 17, the set of cage front ports further comprising a third cage front port, and wherein the set of cage rear ports further comprises a third cage rear port operatively connected to the third cage front port.

19. The caged fan module of claim 18, the set of cage front ports further comprising a fourth cage front port, and wherein the set of cage rear ports further comprises a fourth cage rear port operatively connected to the fourth cage front port.

20. The caged fan module of claim 14, wherein the cage front port and the cage rear port utilize multi-fiber push-on (MPO) technology.
